(19) United States
(12) Patent Application Publication
(10) Pub. No.: US 2010/0165634 A1
(43) Pub. Date: Jul. 1, 2010

(54) Ultra-thin light guidance device

(76) Inventors: Hei-Tai Hong, Hsin-Chu (TW); Huai-Fang Tsai, Hsinchu (TW); Yung-Peng Chang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/318,355

(22) Filed: Dec. 29, 2008

(51) Int. Cl. F21V 7/05; H01J 63/04

(52) U.S. Cl. 362/307; 362/260

(57) ABSTRACT

Disclosed is an ultra-thin light guidance device, which is realized through integrating a micro prism set into a light guidance module, and achieving filtering the incident lights by means of a micro grating in said micro prism set, thus only part of the effective incident lights pass through said micro prism set, while the rest of incident lights are reflected back to a bottom light guidance layer and a bottom light reflection plate, so that lights are reflected back and enters into said micro prism set again. As such, in less than 10 mm thickness of the ultra-thin light guidance device, a dot or a line light source is converted to form an evenly distributed and highly efficient surface light source by making use of said micro prism set.

### BACKGROUND OF THE INVENTION

1. Field of the Invention

The present invention relates to a light guidance module, and in particular to an ultra-thin film light guidance device having uniform illuminance, that is utilized in a backlight module of liquid crystal display (LCD) and a thin profile illumination device.

2. The Prior Arts

Nowadays, along with the rising demand for liquid crystal display screens in the market, and the demand of customer for LCD's of larger sizes and lower prices, backlight module has become one of the crucial components in reducing the size and lowering the price of LCD. The backlight module is built in and integrated wholly in a light crystal display (LCD), its major function is to provide a stable light source for a liquid crystal (LC) panel in front, so that LCD industry has now placed great emphasis on the light-weight, thin-profile, and uniform and high illuminance of backlight module.

Conventionally, a backlight module can be classified as: a direct type backlight module and an edge type backlight module according to its position of placement in an LCD, as shown in FIGS. 1 and 2 respectively. Thus, as shown in FIG. 1, a cold cathode fluorescent lamp (CCFL) or a light-emitting-diode (LED) of a direct type back light module 10 is provided in a lower portion of the entire module, and a reflector plate 14 is usually placed below, so that lights will enter into a diffusion plate 16 directly or through reflection, and then proceeding to a prism plate 18, and finally reaching an LC panel (not shown) and emitting light. In addition, referring to FIG. 2 for an edge type backlight module 20 according to prior art, wherein, a cold cathode fluorescent lamp 22 is placed at a side edge of backlight module, and a reflection plate 24 is used to surround the backlight source, so that only an opening is left for lights to enter into a light guidance plate 26. In a similar manner, a reflection plate 28 is provided below the light guide plate. The major function of light guidance plate 26 is to guide the direction of lights, so that lights entering from a side edge is guided toward an LC panel to emit lights. For this purpose, a number of mesh points or miniature structures are provided at a bottom portion of a light guidance plate to control the distribution density of the emitted light. Then, the emitted light will pass through a diffusion plate 30 and a prism plate 32 closely behind, and finally reaching an LC panel in an uppermost portion (not shown).

In a structure mentioned above, a direct type backlight module is usually utilized in a large-sized LCD, that is because higher density backlight sources can be installed to provide higher illuminance. However, since in this structure, a diffusion plate is made of an opaque polymer, that will absorb parts of lights emitted by a light source, moreover, the application of a diffusion plate requires certain amount of diffusion space, thus being able to eliminate bright spots of a light source; therefore, the volume occupied by a direct type backlight module is larger than that of an edge type backlight module. As such, an edge type backlight module is mostly utilized in providing light to small size screen. Though, the design of edge type light source may have the benefits and advantages of light-weight, thin-profile, narrow-frame and low power consumption, however, since cold cathode fluorescent lamp (CCFL) is used as an edge type backlight light source, thus the density of a backlight source of a backlight module that can be raised is rather limited. Therefore, its light illuminance is rather low and is not suitable to be used as a light source for a larger size displayer.

However, in addition to fulfilling the requirements of high illuminance, uniform distribution, light-weight, and thin-profile of backlight module, the realization of modularized integration of a backlight module is the goal and direction of research and development of the LC screen for the next generation. Therefore, the research and development of a backlight module having various advantages integrated therein is a major goal for the LC industry at present. For this purpose, the present invention provides an ultra-thin light guidance device integrating a micro prism set and a micro grating set, that is capable of meeting the requirements of LCD backlight module at present. Furthermore, this kind of light guidance module can not only be utilized in a backlight module, but it can also be used in a thin profile illuminance device, hereby meeting the demands of market for products having uniform light distribution in a more sufficient manner.

### SUMMARY OF THE INVENTION

In view of the problems and shortcomings of the prior art, a major objective of the present invention is to provide an ultra-thin light guidance device, wherein, the uniformity of emitted light is regulated by the density distribution of micro prism set and micro grating set, thus being able to eliminate bright spots in a light source.

Another objective of the present invention is to provide an ultra-thin light guidance device, and that is realized by directly integrating a micro prism set and a light guidance layer, hereby reducing the thickness of the entire backlight module.

Still another objective of the present invention is to provide an ultra-thin light guidance device, that is suitable to be used as light source of various designs, and for a variety of applications.

According to an aspect of the present invention, an ultra-thin light guidance device of the present invention includes a bottom light guidance layer, a set of micro prisms are disposed thereon, and a micro grating is embedded in the set of micro prisms. Moreover, an upper light guidance layer and a diffusion layer are disposed on the micro prism set. As such, when incident lights pass through the bottom light guidance layer and reach the micro prism set, part of the lights are refracted and transmitted through a micro grating by a refraction angle, and another portion of incident lights are reflected directly by the micro grating, and then is reflected back to the micro prism set through a bottom reflection plate. The above-mentioned processes are repeated until lights pass through the micro prism set, and then emerge by passing through an upper light guidance layer and a diffusion layer. Therefore, this kind of design of light guidance device can not only reduce the thickness of the module,-but it can also provide lights of uniform distribution and high illuminance as required by a liquid crystal display or an LED lighting device.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a cross section view of a structure of a direct type backlight module according to the prior art;

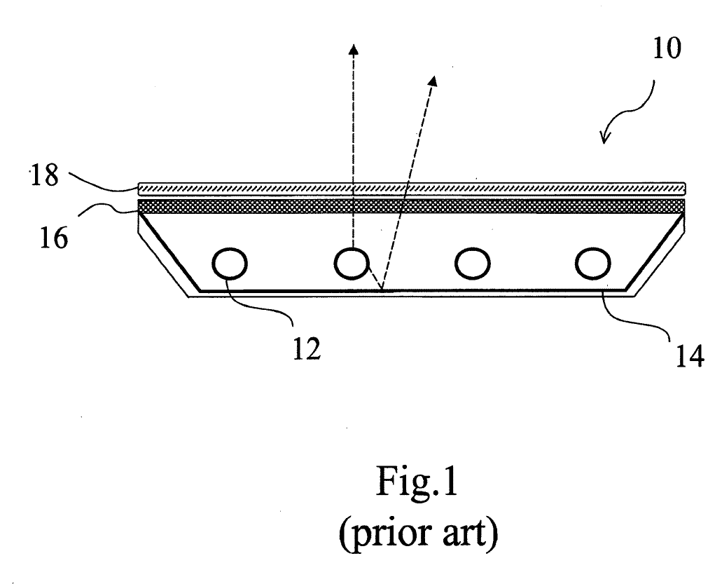

FIG. 2 is a cross section view of a structure of an edge type backlight module according to the prior art;

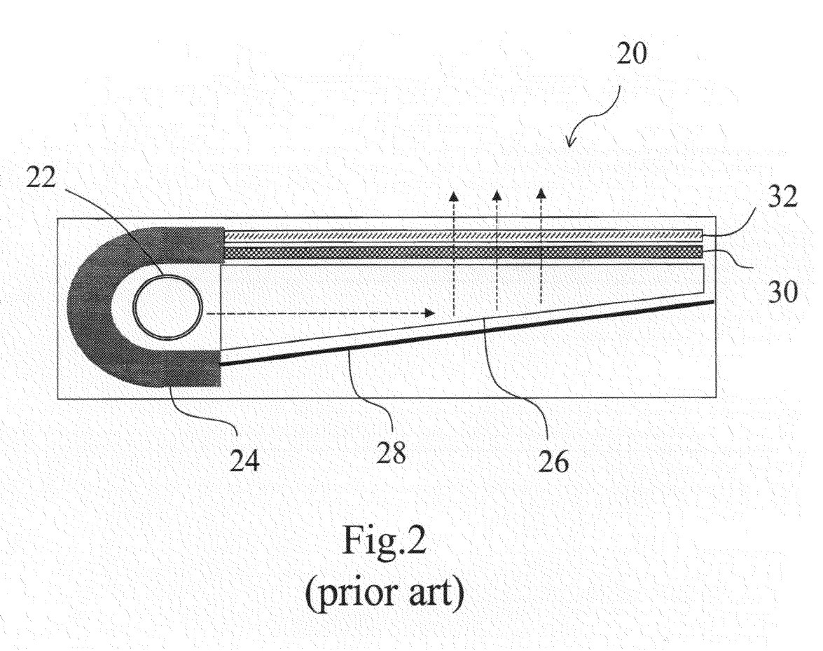

FIG. 3 is a cross section view of a structure of an ultra-thin light guidance device according to a first embodiment of the present invention;

FIG. 4 is a cross section view of a structure of an ultra-thin light guidance device according to a second embodiment of the present invention;

FIG. 5 is an illuminance uniformity simulation result of an ultra-thin light guidance device according to an embodiment of the present invention; and

FIG. 6 is an illuminance uniformity simulation result of an ultra-thin light guidance device without a micro prism set according to an embodiment of the present invention.

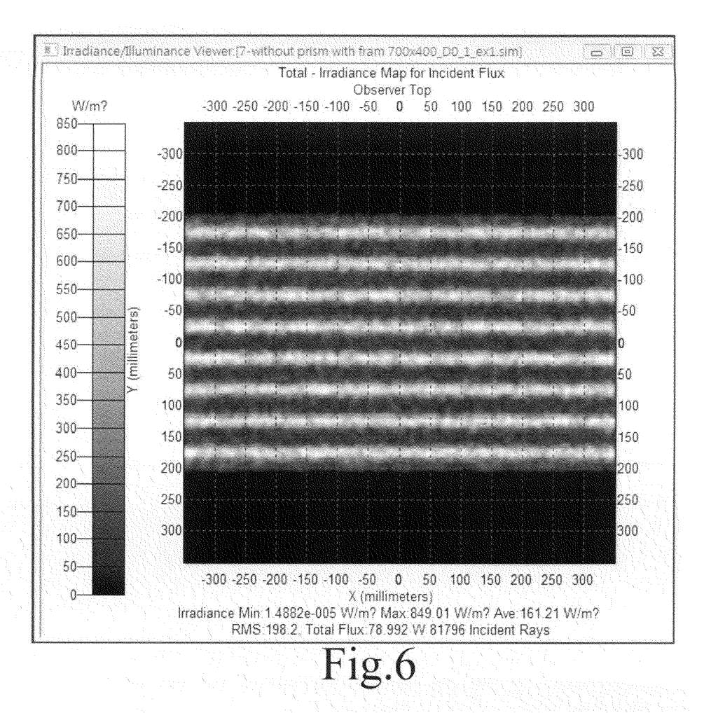

### DETAILED DESCRIPTION OF THE PREFERRED EMBODIMENT

The purpose, construction, features, functions and advantages of the present invention can be appreciated and understood more thoroughly through the following detailed description with reference to the attached drawings.

The present invention discloses an ultra-thin light guidance device, its major purpose is to integrate the technical characteristics of light guidance, diffusion, and reflection of the prior art into a light guidance device, so that this light guidance device is thin enough without occupying too much space while having excellent light uniform distribution, hereby improving the light emission efficiency.

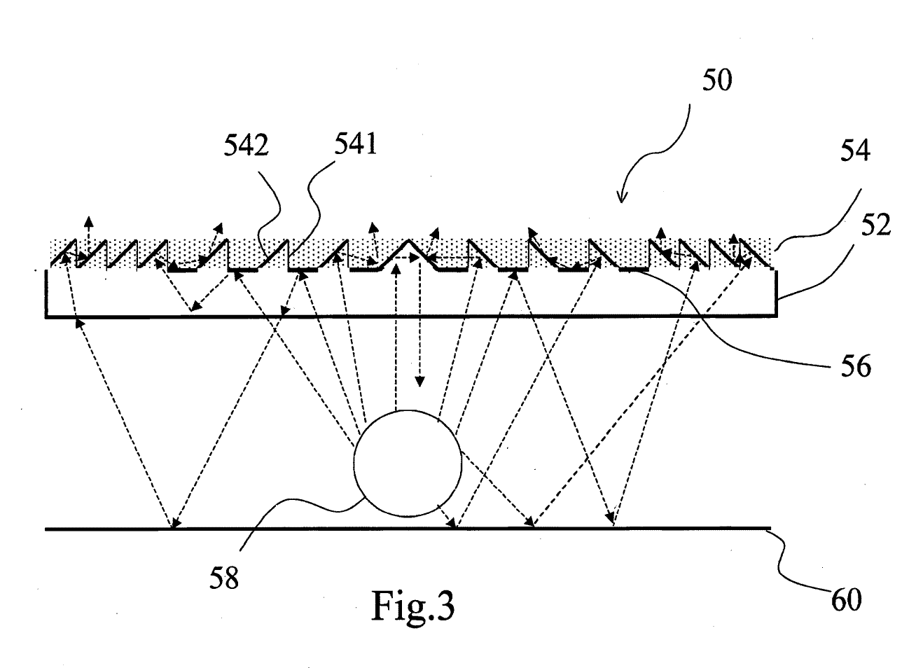

Firstly, referring to FIG. 3 for a cross section view of an ultra-thin light guidance device according to a first embodiment of the present invention. As shown in FIG. 3, an ultra-thin light guidance device 50 of the present invention basically includes; a bottom light guidance layer 52, a bottom reflection plate 60, a micro prism set 54, and at least a light source 58. The bottom light guidance layer 52 is provided above the light source 58, and a bottom reflection plate 60 is disposed below the light source. The micro prism set 54 are provided on an upper surface of the bottom light guidance layer 52, wherein, a micro grating 56 is embedded into a micro prism set 54; moreover, the micro prism set is provided with a transmission plane and a reflection plane, and wherein, the angle between the transmission plane and the reflection plane is greater than or equal to 45 degrees.

Therefore, upon passing through bottom light guidance layer 52 and then reaching micro prism set 54, the incident lights from light source 58 will in part transmit through the micro prism set 54 via a refraction angle, thus exiting the micro prism set 54 and emitting lights into an uniform distribution; on the other hand, the other part of the incident lights will be reflected back to the bottom light guidance layer 52, and then will proceed to and reflected by the bottom reflection plate 60 back into micro prism set 54. Finally, the lights thus obtained will transmit through micro prism set 54 to form a uniformly distributed backlight source without having bright spots.

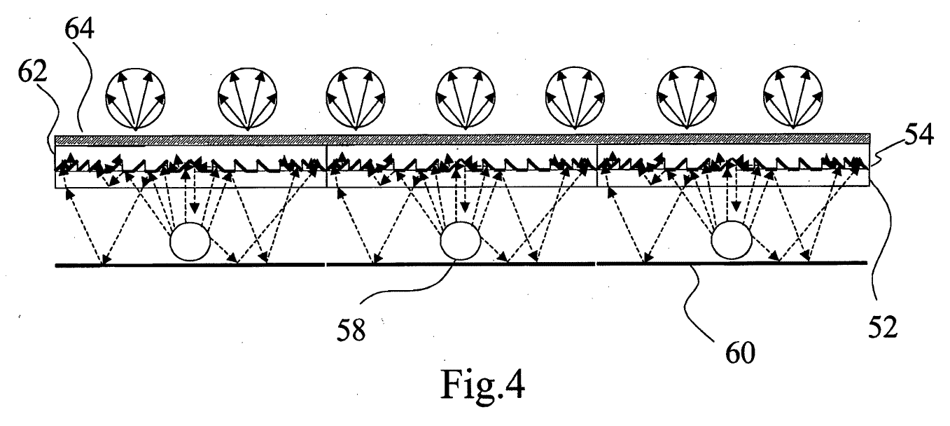

Furthermore, in addition to the first embodiment mentioned above, in a second embodiment of the present invention, an upper light guidance layer 62 is provided on the bottom light guidance layer and covers the micro prism set 54, while a diffusion layer 64 is covered on an upper surface of an upper light guidance layer, as shown in FIG. 4. The purpose and function of the second embodiment is to raise the uniformity of light emitted from the light guidance module. The thickness of the the first embodiment or the second embodiment can be less than 10 mm. Thereby, a dot or a line light source is converted to form an evenly distributed and highly efficient surface light source by the present invention.

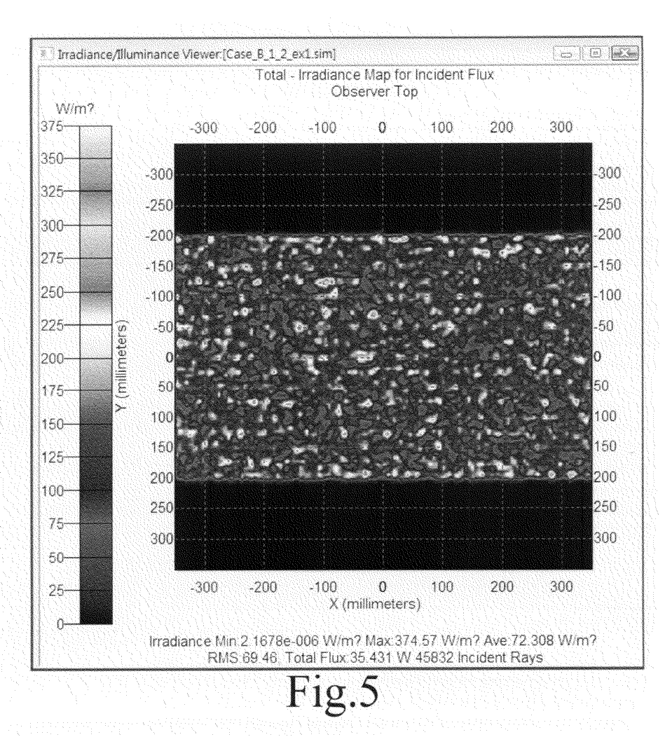

Subsequently, referring to FIGS. 5 & 6 for an illuminance uniformity simulation result of an ultra-thin light guidance device, and an illuminance uniformity simulation result of an ultra-thin film light guidance device without a micro prism set according to an embodiment of the present invention respectively in substantiating that, the uniformity of light transmitted through an ultra-thin light guidance device does indicate remarkable improvements.

Moreover, in the present invention, the bottom light guidance layer 52 is made of Polycarbonate (PC), Polyethylene Terephthalate (PET), or UV light curable glue (UV glue); the micro prism set 54 is made of UV light curable glue (UV glue) and a metal material; and the upper light guidance layer 60 is made of UV light curable glue (UV glue).

Summing up the above, through the application of the present invention, the ultra-thin light guidance device can be utilized in a backlight module of a liquid crystal display (LCD), or an illumination device of a light-emitting-diode (LED), wherein, micro prism set is embedded into light guidance layer to achieve modularized integration, as such, not only the cost, weight, and thickness of backlight module are reduced, but it also has the advantage in illuminance and uniformity of light as compared with ordinary light guidance module. Therefore, the ultra-thin light guidance device of the present invention is suitable for use in large amount in various optical devices.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. An ultra-thin light guidance device, comprising:
a light source, used to provide incident lights;
a bottom reflection plate, is disposed below said light source;
a bottom light guidance layer, used to receive said incident lights; and
a micro prism set, including a micro grating disposed on an upper surface of said bottom light guidance layer, part of said incident lights are transmitted through said micro prism set, and part of said incident lights are reflected by said micro grating back to said bottom light guidance layer, and is reflected by said bottom reflection plate back again to said micro prism set.

2. The ultra-thin light guidance device as claimed in claim 1, wherein
said micro prism set further includes a transmission plane and a reflection plane.

3. The ultra-thin light guidance device as claimed in claim 2, wherein
an angle between said transmission plane and said reflection plane is greater than or equal to 45 degrees.

4. The ultra-thin light guidance device as claimed in claim 1, further comprising:
an upper light guidance layer provided on said bottom light guidance layer and covering said micro prism set.

5. The ultra-thin light guidance device as claimed in claim 4, further comprising:
a diffusion layer covering an upper surface of said upper light guidance layer.

6. The ultra-thin light guidance device as claimed in claim 1, wherein
said light source is a cold cathode fluorescence light (CCFL) or a light-emitting-diode (LED).

7. The ultra-thin light guidance device as claimed in claim 1, wherein
said bottom light guidance layer is made of Polycarbonate (PC), Polyethylene Terephthalate (PET), or UV light curable glue (UV glue).

8. The ultra-thin light guidance device as claimed in claim 1, wherein
said micro prism set is made of UV light curable glue (UV glue) and a metal material.

9. The ultra-thin light guidance device as claimed in claim 5, wherein
said upper light guidance layer is made of UV light curable glue (UV glue).
